(19) United States
(12) Patent Application Publication
(10) Pub. No.: US 2011/0025446 A1
(43) Pub. Date: Feb. 3, 2011

(54) APPARATUS AND METHOD FOR EFFECTING INDUCTIVE COUPLING AMONG A PLURALITY OF ELECTRICAL ELEMENTS

(75) Inventors: Robert James Catalano, Mesquite, TX (US); Roger Dale Grandchampt, Dallas, TX (US); William Lonzo Woods, JR., Kaufman, TX (US)

Correspondence Address: LAW OFFICE OF DONALD D. MONDUL, PO Box 1203, 354 Moose Lane, Seeley Lake, MT, 59868-1203, US

(73) Assignee: Lineage Power Corporation, a Corp. of Nevada, Plano, TX (US)

(21) Appl. No.: 12/534,690

(22) Filed: Aug. 3, 2009

(51) Int. Cl. H01F 17/04; H01F 41/00

(52) U.S. Cl. 336/221; 29/606

(57) ABSTRACT

An apparatus for effecting inductive coupling among a plurality of electrical elements includes: (a) an electrically non-conductive core member oriented about an axis; (b) at least one first electrical element of the plurality of electrical elements substantially nestingly surrounding the core member oriented about the axis; each respective first electrical element being in spaced relation vis-à-vis other first electrical elements in an installed orientation; and (c) at least one second electrical element of the plurality of electrical elements disposed in surrounding relation with respect to the core member about the axis sufficiently proximal with at least one selected said first electrical element in the installed orientation to establish the inductive coupling.

### TECHNICAL FIELD

The present invention is directed to electrical inductively coupled devices, and especially to electrical inductively coupled devices presenting a relatively small package in their assembled state.

### BACKGROUND

Power magnetic components that are intended to carry large currents tend to be large due to the necessities of insulation and lead-out considerations. This large size results in high thermal resistance making cooling of such devices problematic, both in convection cooled and air cooled designs. The lead-outs are often wires soldered to sheet copper windings. This lead-out structure may present an electrical loss mechanism because of high inherent DC resistance generally resulting from a combination of the wire resistance and the resistance of the solder joints. The complexity of such a configuration adds to production costs. Further, manufacturing variation of the wellness of solder joints can reduce the overall stability and efficiency of the device during operation in a circuit.

There is a need for an apparatus and method for effecting inductive coupling among a plurality of electrical elements that can yield a power magnetic component of compact volume capable of handling large currents and is amenable to repeatable, reliable manufacture at a relatively low cost.

### SUMMARY

An apparatus for effecting inductive coupling among a plurality of electrical elements includes: (a) an electrically non-conductive core member oriented about an axis; (b) at least one first electrical element of the plurality of electrical elements substantially nestingly surrounding the core member oriented about the axis; each respective first electrical element being in spaced relation vis-à-vis other first electrical elements in an installed orientation; and (c) at least one second electrical element of the plurality of electrical elements disposed in surrounding relation with respect to the core member about the axis sufficiently proximal with at least one selected said first electrical element in the installed orientation to establish the inductive coupling.

A method for configuring a plurality of electrical elements for effecting inductive coupling among the plurality of electrical elements includes: (a) in no particular order: (1) providing a substantially electrically non-conductive core member; (2) providing at least one first electrical element of the plurality of electrical elements; and (3) providing at least one second electrical element of the plurality of electrical elements; (b) orienting the core member about an axis; (c) orienting the at least one first electrical element substantially nestingly surrounding the core member oriented about the axis; each respective the at least one first electrical element being in spaced relation vis-à-vis other first electrical elements of the at least one first electrical element in an installed orientation; and (d) orienting the at least one second electrical element disposed in surrounding relation with respect to the core member about the axis; the at least one second electrical element being sufficiently proximal with at least one selected first electrical element in the installed orientation to establish the inductive coupling.

It is, therefore, a feature of the present invention to provide an apparatus and method for effecting inductive coupling among a plurality of electrical elements that can yield a power magnetic component of compact volume capable of handling large currents and is amenable to repeatable, reliable manufacture at a relatively low cost.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a perspective schematic drawing of selected elements of an inductively coupling apparatus configured according to the teachings of the present invention.

FIG. 2 is a perspective view of a representative alternate embodiment of an electrical element configured for use in the assembly illustrated in FIG. 1.

FIG. 3 is an orthogonal view of the electrical element illustrated in FIG. 2.

FIG. 4 is a side view in partial section of a representative inductive apparatus configured according to the teachings of the present invention.

FIG. 5 is an isometric diagram of an electromagnetic core element configured for use with the present invention.

FIG. 6 is a flow chart illustrating the method of the present invention.

### DETAILED DESCRIPTION OF THE PREFERRED EMBODIMENT

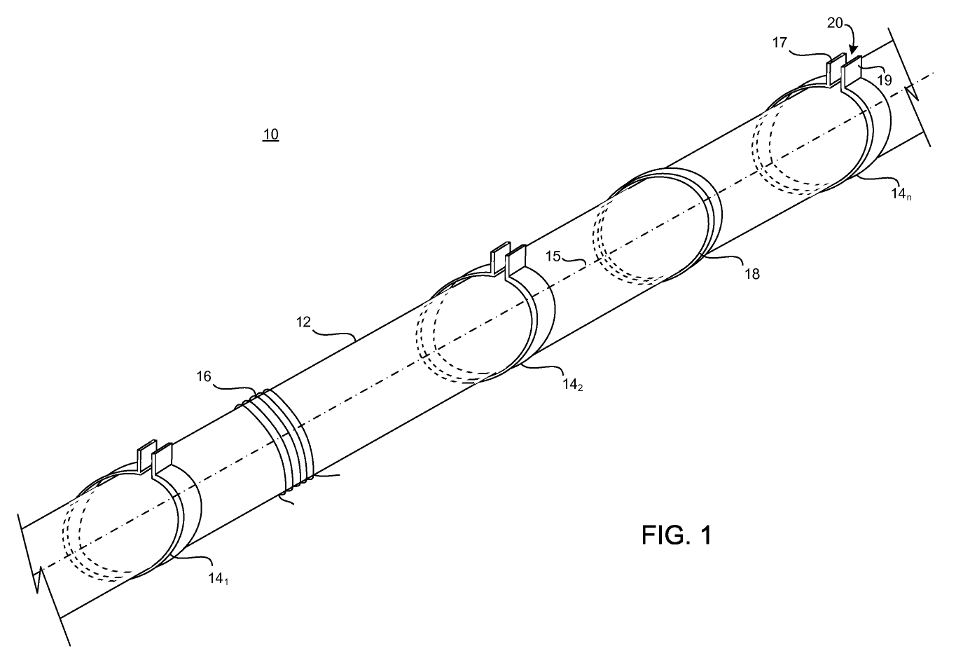

FIG. 1 is a perspective schematic drawing of selected elements of an inductively coupling apparatus configured according to the teachings of the present invention. In FIG. 1, an apparatus 10 includes a core member 12 and a plurality of first electrical elements 14₁, 14₂,14ₙ substantially nestingly surrounding core member 12. The indicator “n” is employed to signify that there can be any number of first electrical elements employed in apparatus 10. The inclusion of three first electrical elements 14₁, 14₂,14ₙ in FIG. 1 is illustrative only and does not constitute any limitation regarding the number of first electrical elements that may be employed with the apparatus of the present invention. Throughout this description, use of a reference numeral using a generic subscript herein may be taken to mean that any respective member of the plurality of elements having the same reference numeral may be regarded as included in the description. Thus, by way of example and not by way of limitation, referring to a first electrical elements 14ₙ in describing FIG. 1 may be taken to mean that any first electrical element—14₁, 14₂ or 14ₙ (FIG. 1)—may be regarded as capable of employment as described.

Apparatus 10 further includes at least one second electrical element 16 in surrounding relation with respect to core member 12. A second electrical element 16 may be embodied in a coiled round wire, a coiled flat wire or sheet foil, or other planar or three-dimensional winding structure. Preferably, first electrical elements 14ₙ and second electrical elements 16 are disposed in close proximity in an installed orientation on core member 12 so as to facilitate establishing inductive coupling among first electrical elements 14ₙ and second electrical elements 16. Electrical insulation is desired among electrical elements 14ₙ, 16 as will be understood by those skilled in the art of inductive device design. By way of example and not by way of limitation, appropriate insulation may be provided by configuring second electrical element 16 in a wound insulated round wire structure. The orientation of apparatus 10 illustrated in FIG. 1 is a somewhat exploded view and is not representative of an installed orientation appropriate to establish inductive coupling among first electrical elements 14ₙ and second electrical elements 16.

An insulating spacer element 18 may be installed between adjacent first electrical elements 14ₙ if desired to assure electrical insulation between adjacent first electrical elements 14ₙ.

An inductively coupled apparatus 10 assembled with first electrical elements 14₁, 14₂ in close proximity with second electrical element 16 may establish, by way of example and not by way of limitation, a transformer device with second electrical element 16 performing as a primary winding or element, and with first electrical elements 14₁, 14₂ performing as secondary windings or elements.

A representative first electrical element 14ₙ will be described in detail. First electrical element 14ₙ is configured as a split-ring having an inside diameter appropriate to permit installation of first electrical element 14ₙ in a nestingly surrounding relation about core member 12 so that core member 12 and first electrical element 14ₙ are substantially coaxially oriented about a common axis 15 in an installed orientation with first electrical elements 14ₙ in sufficiently close proximity with a second electrical element 16 to establish inductive coupling among first electrical elements 14ₙ and second electrical element 16. In the installed orientation, first electrical element 14ₙ presents a pair of tabs 17, 19 adjacent a gap 20. Tabs 17, 19 extend in two circumferential sectors in a direction away from axis 15 a distance beyond second electrical element 16 sufficient to present electrical access to first electrical elements 14ₙ in the installed orientation.

Spacer element 18 may be fashioned in a ring structure of non-conducting material having an inside diameter appropriate to permit installation of spacer element 18 in a nestingly surrounding relation about core member 12 so that core member 12 and spacer element 18 are substantially coaxially oriented about common axis 15 in the installed orientation. Alternately, spacer element 18 may be integrally formed as a portion of core member 12.

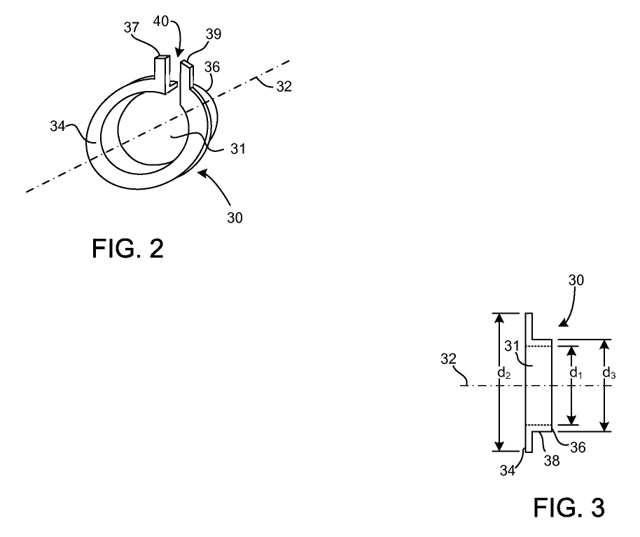

FIG. 2 is a perspective view of a representative alternate embodiment of an electrical element configured for use in the assembly illustrated in FIG. 1. FIG. 3 is an orthogonal view of the electrical element illustrated in FIG. 2. Regarding FIGS. 1 and 2 together, a first electrical element 30 is configured in a split-ring configuration than can be oriented about an axis 32. First electrical element 30 presents an aperture 31 having an internal diameter d₁ of an appropriate dimension to permit installing first electrical element 30 in an installed orientation in a substantially nesting surrounding relation with a core member (e.g., core member 12; FIG. 1) leaving a gap 40. In such an installed orientation, axes 15, 32 would be substantially coincident. First electrical element 30 has a first face 34 with an outside diameter d₂ and a second face 36 with an outside diameter d₃. Outside diameter d₃ is smaller than outside diameter d₂ and larger than inside diameter d₁.

First face 34 presents tabs 37, 39 extend in two circumferential sectors adjacent to gap 40 in a direction away from axis 32 to present electrical access to first electrical element 30 in an installed orientation.

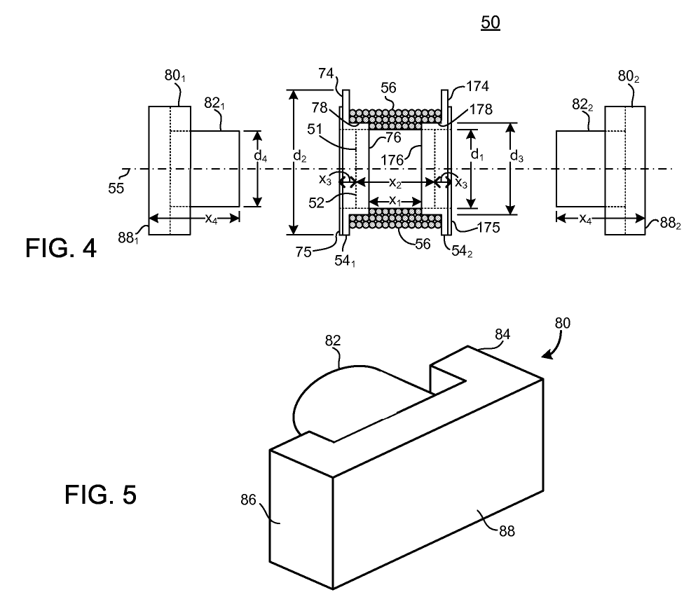

Differing outside diameters d_{2,} d₃ result in second electrical element 30 presenting a substantially circumferential ledge 38 (save for gap 40). In an installed orientation, a second electrical element (e.g., a wound round wire element; see FIG. 1) may be oriented between adjacent first electrical elements 30 with ledges 38 in facing relation but presenting a gap therebetween. A second electrical element may be installed atop ledges 38 of each adjacent first electrical element 30 to further enhance inductive coupling between first electrical elements 30 and a second electrical element. Such an orientation is illustrated in FIG. 4.

FIG. 4 is a side view in partial section of a representative inductive apparatus configured according to the teachings of the present invention. In FIG. 4, an apparatus 50 includes a core member 52 oriented about an axis 55. Core member 52 is received within two first electrical elements 54₁, 54₂ in a substantially nesting surrounding orientation. First electrical element 54₁ has a first face 74 and a second face 76. First electrical element 54₂ has a first face 174 and a second face 176. An insulating structure 75 may be situated adjacent first face 74. An insulating structure 175 may be situated adjacent first face 174. Insulating structures 75, 175 may be configured as insulating washers, as an insulating coating applied to first faces 74, 174 or another structure employed by those skilled in the art of power component design for effecting an insulating function. Second faces 76, 176 are in facing relation separated by a distance x₁. First electrical elements 54₁, 54₂ are in spaced relation so that core member 52, having a length x₂ is displaced a substantially equal distance x₃ from each of insulating structures 75, 175.

First electrical elements 54₁, 54₂ present an aperture 51 having an internal diameter d₁ of an appropriate dimension to permit installing first electrical elements 54₁, 54₂ in an installed orientation in a substantially nesting surrounding relation with core member 51 leaving a gap (e.g., gap 40; FIG. 2). First faces 74, 174 present an outside diameter d₂. Second faces 76, 176 present an outside diameter d₃. Outside diameter d₃ is smaller than outside diameter d₂ and larger than inside diameter d₁.

First faces 74, 174 each present tabs (e.g., tabs 37, 39; FIG. 2; tabs are not visible in FIG. 4) that extend in two circumferential sectors in a direction away from axis 55 to present electrical access to first electrical elements 54₁, 54₂ in an installed orientation.

Differing outside diameters d_{2,} d₃ result in first electrical element 54₁ presenting a substantially circumferential ledge 78. Differing outside diameters d_{2,} d₃ result in first electrical element 54₂ presenting a substantially circumferential ledge 178. Second electrical element 56 is applied in circumferential relation about core member 51 and overlaying ledges 78, 178.

The structures of first electrical elements 54₁, 54₂ present L-shaped profiles in planes containing axis 55. The L-shaped profiles present first legs 45₁, 45₂ substantially perpendicular with axis 55 and present a second leg extending a distance generally parallel with axis 55 embodied in ledges 78, 178. The second legs embodied in ledges 78, 178 effect a substantially nesting, surrounding, abutting relation with core member 52 along the distance in the installed orientation.

Second electrical element 56 is disposed in the surrounding relation generally covering the second leg or ledge 78, 178 of adjacent first electrical elements 54₁, 54₂ in the installed orientation. The L-shaped profile of first electrical elements 54₁, 54₂ permits first electrical elements 54₁, 54₂ to inductively couple with second electrical element 56 in two dimensions in planes containing axis 55, thereby avoiding a need for interleaving first electrical elements 54₁, 54₂ with second electrical element 56 to effect efficient inductive coupling.

Electromagnetic core elements 80₁, 80₂ may be installed with apparatus 50 to enhance inductive coupling among first electrical elements 54₁, 54₂ and second electrical element 56. In such a configuration, second electrical element 56 may operate as a primary element or winding, and first electrical elements 54₁, 54₂ may operate as secondary elements or windings of a transformer device.

Electromagnetic core element 80₁ includes an insertion element 82₁ presenting an outside diameter d₄. Diameter d₄ is dimensioned to be received within core member 52. Insertion element 82₁ extends a distance x₄ from a rear supporting wall 88₁. Distance x₄ is dimensioned to assure sufficient insertion of insertion member 82₁ within core member 52 to provide stability for electromagnetic core member 80₁ when in an installed orientation in apparatus 50.

Electromagnetic core element 80₂ includes an insertion element 82₂ presenting an outside diameter d₄. Diameter d₄ is dimensioned to be received within core member 52. Insertion element 82₂ extends a distance x₄ from a rear supporting wall 88₁. Distance x₄ is dimensioned to assure sufficient insertion of insertion member 82₂ within core member 52 to provide stability for electromagnetic core member 80₂ when in an installed orientation in apparatus 50.

Distance x₄ may be selected to permit electromagnetic core elements 80₁, 80₂ to be in an abutting relation when installed to assure no gaps are established between electromagnetic core elements 80₁, 80₂. Distance x₄ may be selected to avoid abutting between electromagnetic core elements 80₁, 80₂ when installed if it is desired that a gap be established between electromagnetic core elements 80₁, 80₂.

FIG. 5 is an isometric diagram of an electromagnetic core element configured for use with the present invention. In FIG. 5, an electromagnetic core element 80 includes side walls 84, 86 connected by a rear supporting wall 88. Rear supporting wall 88 supports an insertion element 82. Electromagnetic core element 80 may be configured as an integral structure presenting side walls 84, 86; rear supporting wall 88 and insertion element 82 in a one-piece unit.

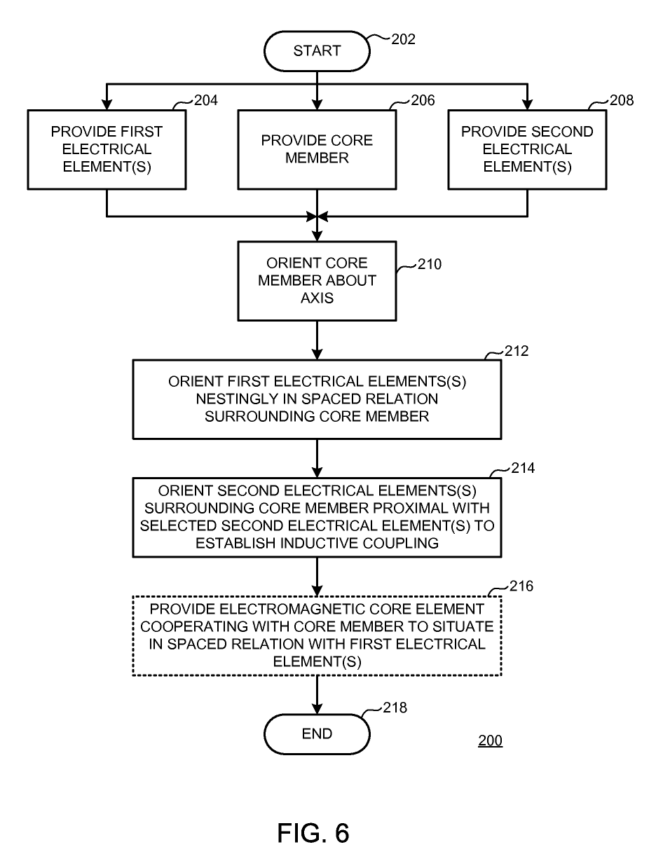

FIG. 6 is a flow chart illustrating the method of the present invention. In FIG. 6, a method 200 for configuring a plurality of electrical elements for effecting inductive coupling among the plurality of electrical elements begins at a START locus 202. Method 200 continues with, in no particular order: (1) providing a substantially electrically non-conductive core member, as indicated by a block 204; (2) providing at least one first electrical element of the plurality of electrical elements, as indicated by a block 206; and (3) providing at least one second electrical element of the plurality of electrical elements, as indicated by a block 208.

Method 200 continues with orienting the core member about an axis, as indicated by a block 210.

Method 200 continues with orienting the at least one first electrical element substantially nestingly surrounding the core member oriented about the axis, as indicated by a block 212. Each respective at least one first electrical element is in spaced relation vis-à-vis other first electrical elements of the at least one first electrical element in an installed orientation.

Method 200 continues with orienting the at least one second electrical element disposed in surrounding relation with respect to the core member about the axis, as indicated by a block 214. The at least one second electrical element is sufficiently proximal with at least one selected first electrical element in the installed orientation to establish the inductive coupling.

Method 200 may continue with providing an electromagnetic core element, as indicated by a block 216. The electromagnetic core element may be oriented for cooperating with the core member to situate the electromagnetic core element in spaced relation with respect to the at least one first electrical element while enhancing the inductive coupling in the installed orientation. The alternative or optional nature of this method step represented by block 216 is indicated by presenting block 216 in a dotted line format.

Method 200 terminates at an end locus 218.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. An apparatus for effecting inductive coupling among a plurality of electrical elements; the apparatus comprising:
(a) a core member; said core member being oriented about an axis and being substantially electrically non-conductive;
(b) at least one first electrical element of said plurality of electrical elements substantially nestingly surrounding said core member oriented about said axis;
each respective said at least one first electrical element being in spaced relation vis-à-vis other first electrical elements of said at least one first electrical element in an installed orientation; and
(c) at least one second electrical element of said plurality of electrical elements being disposed in surrounding relation with respect to said core member about said axis; said at least one second electrical element being sufficiently proximal with at least one selected said first electrical element in said installed orientation to establish said inductive coupling.

2. The apparatus for effecting inductive coupling among a plurality of electrical elements as recited in claim 1 wherein each said respective at least one first electrical element presents an L-shaped profile in planes containing said axis; said L-shaped profile presenting a first leg substantially perpendicular with said axis and presenting a second leg extending a distance generally parallel with said axis; said second leg effecting said substantially nesting surrounding in an abutting relation with said core member along said distance in said installed orientation.

3. The apparatus for effecting inductive coupling among a plurality of electrical elements as recited in claim 2 wherein said at least one second electrical element is disposed in said surrounding relation generally covering said second leg of at least one said at least one first electrical element adjacent to said at least one second electrical element in said installed orientation.

4. The apparatus for effecting inductive coupling among a plurality of electrical elements as recited in claim 2 wherein said first leg extends beyond said at least one second electrical element in said installed in orientation in at least two circumferential sectors of said at least one first electrical element to present electrical access to said at least one first electrical element in said installed orientation.

5. The apparatus for effecting inductive coupling among a plurality of electrical elements as recited in claim 1 wherein the apparatus further comprises an electromagnetic core element; said electromagnetic core element cooperating with said core member to situate said electromagnetic core element in spaced relation with respect to said at least one first electrical element while enhancing said inductive coupling in said installed orientation.

6. The apparatus for effecting inductive coupling among a plurality of electrical elements as recited in claim 5 wherein each said respective at least one first electrical element presents an L-shaped profile in planes containing said axis; said L-shaped profile presenting a first leg substantially perpendicular with said axis and presenting a second leg extending a distance generally parallel with said axis; said second leg effecting said substantially nesting surrounding in an abutting relation with said core member along said distance in said installed orientation.

7. The apparatus for effecting inductive coupling among a plurality of electrical elements as recited in claim 6 wherein said at least one second electrical element is disposed in said surrounding relation generally covering said second leg of at least one said at least one first electrical element adjacent to said at least one second electrical element in said installed orientation.

8. The apparatus for effecting inductive coupling among a plurality of electrical elements as recited in claim 7 wherein said first leg extends beyond said at least one second electrical element in said installed in orientation in at least two circumferential sectors of said at least one first electrical element to present electrical access to said at least one first electrical element in said installed orientation.

9. An apparatus for effecting inductive coupling among at least one primary electrical element and a plurality of secondary electrical elements; the apparatus comprising:
(a) a substantially cylindrical core member; said core member being oriented about an axis and being substantially electrically non-conductive;
(b) each respective secondary electrical element of said plurality of secondary electrical elements substantially nestingly surrounding said core member; each said respective secondary electrical element being in spaced relation vis-à-vis other said respective secondary electrical elements in an installed orientation; and
(c) each respective primary electrical element of said at least one primary electrical element being disposed in surrounding relation with respect to said core member; each said respective primary electrical element being sufficiently near at least one proximal said respective secondary electrical element in said installed orientation to establish said inductive coupling with said at least one proximal respective secondary element.

10. The apparatus for effecting inductive coupling among at least one primary electrical element and a plurality of secondary electrical elements as recited in claim 9 wherein each said respective secondary electrical element presents an L-shaped profile in planes containing said axis; said L-shaped profile presenting a first leg substantially perpendicular with said axis and presenting a second leg extending a distance generally parallel with said axis; said second leg effecting said substantially nesting surrounding in an abutting relation with said core member along said distance in said installed orientation.

11. The apparatus for effecting inductive coupling among at least one primary electrical element and a plurality of secondary electrical elements as recited in claim 10 wherein each said respective primary electrical element is disposed in said surrounding relation generally covering said second leg of at least one said respective secondary electrical element adjacent to said at least one respective secondary electrical element in said installed orientation.

12. The apparatus for effecting inductive coupling among at least one primary electrical element and a plurality of secondary electrical elements as recited in claim 10 wherein said first leg extends beyond each said respective primary electrical element in said installed in orientation in at least two circumferential sectors of each said respective secondary electrical element to present electrical access to each said respective secondary electrical element.

13. The apparatus for effecting inductive coupling among at least one primary electrical element and a plurality of secondary electrical elements as recited in claim 9 wherein the apparatus further comprises an electromagnetic core element; said electromagnetic core element cooperating with said core member to situate said electromagnetic core element in spaced relation with respect to each said respective secondary electrical element while enhancing said inductive coupling in said installed orientation.

14. The apparatus for effecting inductive coupling among at least one primary electrical element and a plurality of secondary electrical elements as recited in claim 13 wherein each said respective secondary electrical element presents an L-shaped profile in planes containing said axis; said L-shaped profile presenting a first leg substantially perpendicular with said axis and presenting a second leg extending a distance generally parallel with said axis; said second leg effecting said substantially nesting surrounding in an abutting relation with said core member along said distance in said installed orientation.

15. The apparatus for effecting inductive coupling among at least one primary electrical element and a plurality of secondary electrical elements as recited in claim 14 wherein said each said respective primary electrical element is disposed in said surrounding relation generally covering said second leg of at least one said respective secondary electrical element adjacent to said at least one said respective secondary electrical element in said installed orientation.

16. The apparatus for effecting inductive coupling among at least one primary electrical element and a plurality of secondary electrical elements as recited in claim 15 wherein said first leg extends beyond each said respective primary electrical element in said installed in orientation in at least two circumferential sectors of each said respective secondary electrical element to present electrical access to each said respective secondary electrical element in said installed orientation.

17. A method for configuring a plurality of electrical elements for effecting inductive coupling among said plurality of electrical elements; the method comprising:
(a) in no particular order:
(1) providing a substantially electrically non-conductive core member;
(2) providing at least one first electrical element of said plurality of electrical elements; and
(3) providing at least one second electrical element of said plurality of electrical elements;
(b) orienting said core member about an axis;
(c) orienting said at least one first electrical element substantially nestingly surrounding said core member oriented about said axis; each respective said at least one first electrical element being in spaced relation vis-à-vis other first electrical elements of said at least one first electrical element in an installed orientation; and
(d) orienting said at least one second electrical element disposed in surrounding relation with respect to said core member about said axis; said at least one second electrical element being sufficiently proximal with at least one selected said first electrical element in said installed orientation to establish said inductive coupling.

18. The method for configuring a plurality of electrical elements for effecting inductive coupling among said plurality of electrical elements as recited in claim 17 wherein each said respective at least one first electrical element presents an L-shaped profile in planes containing said axis; said L-shaped profile presenting a first leg substantially perpendicular with said axis and presenting a second leg extending a distance generally parallel with said axis; said second leg effecting said substantially nesting surrounding in an abutting relation with said core member along said distance in said installed orientation, and wherein said at least one second electrical element is disposed in said surrounding relation generally covering said second leg of at least one said at least one first electrical element adjacent to said at least one second electrical element in said installed orientation.

19. The method for configuring a plurality of electrical elements for effecting inductive coupling among said plurality of electrical elements as recited in claim 18 wherein the method further comprises providing an electromagnetic core element; said electromagnetic core element being oriented for cooperating with said core member to situate said electromagnetic core element in spaced relation with respect to said at least one first electrical element while enhancing said inductive coupling in said installed orientation.

20. The method for configuring a plurality of electrical elements for effecting inductive coupling among said plurality of electrical elements as recited in claim 19 wherein said first leg extends beyond said at least one second electrical element in said installed in orientation in at least two circumferential sectors of said at least one first electrical element to present electrical access to said at least one first electrical element in said installed orientation.
